(19) United States
(12) Patent Application Publication
(10) Pub. No.: US 2006/0008081 A1
(43) Pub. Date: Jan. 12, 2006

(54) Modular-multiplication computing unit and information-processing unit

(75) Inventors: Kunihiko Higashi, Kawasaki-shi (JP); Toru Hisakado, Kawasaki-shi (JP); Satoshi Goto, Kitakyushu-shi (JP); Takeshi Ikenaga, Kitakyushu-shi (JP)

Correspondence Address: SUGHRUE MION, PLLC, 2100 PENNSYLVANIA AVENUE, N.W., SUITE 800, WASHINGTON, DC, 20037, US

(73) Assignees: NEC ELECTRONICS CORPORATION; WASEDA UNIVERSITY

(21) Appl. No.: 11/176,222

(22) Filed: Jul. 8, 2005

(30) Foreign Application Priority Data
Jul. 9, 2004 (JP) 2004-203435

(51) Int. Cl. H04K 1/00

(52) U.S. Cl. 380/28

(57) ABSTRACT

Either a multiplicand A or 0 is selected, depending on the value of multiplier B supplied in a unit composed of q bits through the use of selectors, and the selected result is provided, and either a multiplicand u or 0 is selected, depending on the value of multiplier N supplied in a unit composed of q bits through the use of selectors, and the selected result is provided. A carry save adder implements the operation of A×B+u×N making use of the values successively supplied from the selectors. To the operation result of A×B+u×N supplied from the carry save adder in a unit composed of q bits is added the operation result of A×B+u×N in the past supplied in a unit composed of q bits and the added result is issued as a result of the modular-multiplication operation S.

### BACKGROUND OF THE INVENTION

1. Field of Invention

The present invention relates to a modular-multiplication computing unit for efficiently implementing a modular exponentiation operation and an information-processing unit having the same.

2. Description of the Related Art

Recent dramatic progress in the processing capabilities of a variety of information processing devices, for example, personal computers, PDA (Personal Digital (Data) Assistance), mobile phones, etc. and further, recent advances in improving the capacities of a variety of recording media and advances in the provision of communication infrastructure have been increasing the occasions in which personal information, business information, etc. communicate through networks and radio means. Consequently, technology for maintaining the secrecy of information and preventing leakage to third parties has become more important.

As general means to keep secret communication data, the common key cryptosystem is known as general means to ensure the secrecy of data communications according to which terminal devices that communicate data with each other employ a common key for encrypting and decrypting the data. With the wide spread of electronic commercial transactions such as B-to-B (Business to Business), B-to-C (Business to Consumer), etc., PKI (Public Key Infrastructure) technology has been the subject of considerable focus.

The public key cryptosystem, which is a basic technology of PKI, is a cryptosystem in which transmitted data is encrypted through the use of a public key and received data is decrypted through the use of a private or secret key, which is paired with the public key and not made public. In this public key cryptosystem, the transmission side and the reception side have different keys and it is not necessary to show the private key to the communication partner. Accordingly, the performance of the public key cryptosystem has greater credibility than common key cryptosystems.

In the public key cryptosystem, the RSA (Rivest, Shamir and Adleman) code is mainly used at present (cf. Masaaki Mitani: “Industrial Mathematics For Fresh Start”, The fifth edition, CQ Press, Feb. 1, 2003, pp. 115-122). The RSA code is a cryptosystem that utilizes the difficulty in the factorization into prime factors of the number N, which is a product of two arbitrary prime numbers, and also utilizes various different features of an algebraic number modular N. Modular exponentiation operations (Md mod N) are implemented for encryption and decryption.

A modular exponentiation operation is commonly implemented by being replaced with the repeated operations of the modular-multiplication operation described below: Let, for example, d=19. Then, from d=1+2×(1+2×(0+2×(0+2×1))),

$$\begin{matrix}C = {M}^{d} mod N \\ = {M}^{1 + 2 \times ( 1 + 2 \times ( 0 + 2 \times ( 0 + 2 \times 1 ) ) )} mod N \\ = {( {( {( {( {M}^{1} )}^{2} {M}^{0} )}^{2} {M}^{0} )}^{2} {M}^{1} )}^{2} {M}^{1} mod N \\ = {( {( {( {M}^{2} )}^{2} )}^{2} M )}^{2} M mod N .\end{matrix}$$

The decomposition of d as described above enables reduction in the operation number as compared to simply multiplying M d times, thereby reducing operation time. For reference, there are a variety of known methods for decomposing d, and the above-described approach is one example of such a method.

The modular-multiplication operation as described above, however, is very difficult to be executed efficiently regardless of whether hardware or software is utilized, because the multiplication operation yields a double digit number of calculations and further the multiplication result must be divided by N. For this reason, a variety of approaches have been studied up to now to compute the modular multiplication operation more efficiently. As a typical example, there is a known computation method based on the algorithm called the Montgomery method (cf. for example, JP 2001-527673).

Application of the Montgomery method enables achieving the modular multiplication operation by multiplication and arithmetic addition and subtraction without substantial division. The modular multiplication P (A×B)_{N}=A×B×r⁻ⁿ mod N=S can be obtained according to the procedures, for example, shown in (1) to (8) below, wherein 0≦N<rⁿ, N is an odd number (the N and r are relatively prime to each other), 0≦A<N, 0≦B<N and A=Aₙ₋₁Aₙ₋₂ . . . . A₀ (for example, A₃A₂A₁A₀=1234).
(1) v=−N⁻¹ mod r,
(2) S=0,
(3) for i=0 to n−1 {
(4) S=S+Aᵢ×B
(5) u=S×v mod r
(6) S=S+u×N
(7) S=S/r
(8) }

The modular multiplication operation can be substituted for the repetitive operations of S=S+Aᵢ×B+u×N (i=0 to n−1) based on the above algorithm, and the modular-multiplication computing unit for achieving this process has a configuration, for example, shown in FIG. 1.

FIG. 1 is a block diagram illustrating the configuration of a conventional modular-multiplication computing unit.

As shown in FIG. 1, the conventional modular-multiplication computing unit has a configuration comprising: first latch circuit 51 that keeps the value of said A, which is a multiplicand; second latch circuit 52 that keeps the value of said u, which is a multiplicand; third latch circuit 53 that keeps the value of A+u; selector 57 that selects multiplicand A, u, A+u or 0 H (all bits equal 0) depending on the values of multipliers B and N supplied in a bit-by-bit basis and supplies the selected result; a well known-carry save adder (referred to as CSA) 56 that computes A×B+u×N through the use of the output values of selector 57; and adder 59 that adds modular-multiplication operation result S, that is computed and externally stored, to modular-multiplication operation result S provided from CSA 56 and supplies the added result as a result of the modular-multiplication operation S. For reference, the values of A, u and A+u are supplied to first to third latch circuits 51, 52 and 53, respectively, under control of, for example, a control unit (not shown), and the values of multipliers B, N and 0 H are supplied to selector 57 under control of, for example, a control unit (not shown).

In the modular-multiplication computing unit shown in FIG. 1, multipliers B and N that have the processing bit length of the modular-multiplication computing unit (for example, 512 bits) are provided to selector 57 on a bit-by-bit basis. Further, multiplicands A, u and A+u are stored in the respective latch circuits in a unit of the bit-length corresponding to the processing bit-length of CSA 56 (m bits in FIG. 1) and supplied to CSA 56. Consequently, if, for example, the processing bit length of the modular-multiplication computing unit is 512 bits and the processing bit length of CSA 56 is 128 bits, then the circuitry shown in FIG. 1 completes the operation of A (128 bits)×B (512 bits)+u (128 bits)×N (512 bits) by repeating the selection procedures of multiplicands A, u and A+u 512 times, and further by repeating these procedures 4 times, the circuitry comes to complete the operation of A (512 bits)×B (512 bits)+u (512 bits)×N (512 bits).

Selector 57 selects one of multiplicands A, u and A+u supplied from first to third latch circuits (51 to 53) and 0 H depending on the values of multipliers B and N supplied on a bit-by-bit basis and provides the selected value to CSA 56. CSA 56 computes A×B+u×N by shift-adding multiplicands A, u and A+u and 0 H, successively supplied from selector 57, and while keeping the interim result, provides, as an output, the result of the modular multiplication operation S on a bit-by-bit basis.

In the public key cryptosystem, the RSA code is widely employed at present using the values of 1024 bits for C, M, N and d in the above-described modular exponentiation operation and a further increase is expected in the bit number. In order to execute the modular exponentiation operation for such an increased number of bits, an enormous amount of computation of modular multiplication operation for encryption and decryption must be undertaken. The public key cryptosystem is problematic in that it needs a long processing time for encryption and decryption as compared to the common key cryptosystem, and thus a key issue has been to reduce the operation time required for the modular multiplication operation.

In this regard, with the widespread use of information-processing devices such as mobile phones, PDAs, personal computers, server devices, etc., the market requires products having high processing performance and low cost. Thus, in order to satisfy such requirements, it is fundamentally important to realize a modular-multiplication computing unit that allows not only reducing the operation time required for the modular multiplication operation but also reducing the circuit size.

### SUMMARY OF THE INVENTION

In view of the above problems, it is an object of the present invention to provide a modular-multiplication computing unit that allows further reduction of the operation time and also to provide an information-processing unit with the same.

It is another object of the present invention to provide a modular-multiplication computing unit that allows reduction of the operation time without increasing the circuit size and also to provide an information-processing unit with the same.

In order to attain the above objects, the modular-multiplication computing unit according to the present invention is adapted for computing S=S+A×B+u×N wherein A and u denote multiplicands, B and N denote multipliers and S denotes a result of the modular-multiplication operation, and comprises:
selectors that select either the value of the multiplicand A or the value of 0, depending on the value of the multiplier B supplied in a unit composed of a plurality of bits q, and that supply the selected result and select either the value of said multiplicand u or the value of 0, depending on the value of said multiplier N supplied in a unit composed of said plurality of bits q, and that supply the selected result,
a carry save adder that executes the operation of A×B+u×N through the use of values successively supplied from said selectors, and
an adder that adds the operation result of said A×B+u×N supplied in a q-bit unit from the carry save adder and the relevant operation result made in the past supplied in said q-bit unit, and that supplies the added result as the result of modular-multiplication operation S.

The above described configuration supplies each of the multipliers in a unit of a plurality of bits q to selectors which select either multiplicands or 0 depending on the values of the multipliers to supply the selected result to the carry save adder, and hence it becomes possible to reduce the processing bit length of the carry save adder in inverse proportion to the bit number q. Thus, the operation time can be reduced as compared to the conventional modular-multiplication computing unit.

Moreover, the reduction of the processing bit length of the carry save adder allows reduction of the number of flip-flops included in the carry save adder, thereby reducing the circuit size of the modular-multiplication computing unit.

The above and other objects, features, and advantages of the present invention will become apparent from the following description with reference to the accompanying drawings, which illustrate examples of the present invention.

### BRIEF DESCRIPTION OF THE DRAWINGS

FIG. 1 is a block diagram illustrating the configuration of a conventional modular-multiplication computing unit;

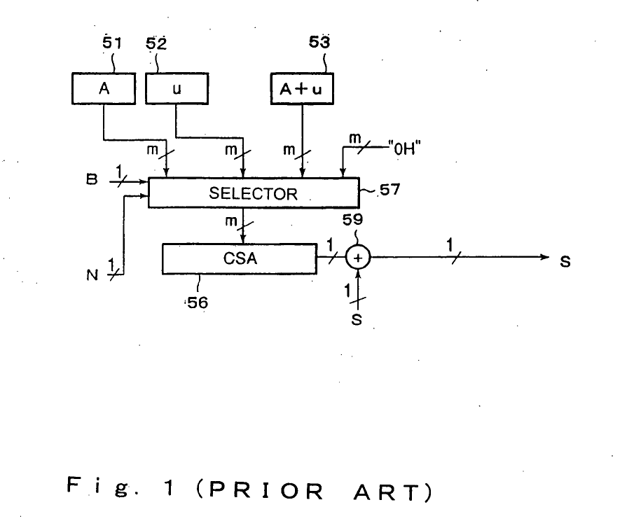

FIG. 2 is a block diagram illustrating an example of a configuration of the modular-multiplication computing unit according to the present invention;

FIG. 3 is a block diagram illustrating an example of a configuration of the information processing unit according to the present invention;

FIG. 4 is a schematic diagram illustrating the procedures of the operation of A×B in the computation to be implemented by the modular-multiplication computing unit according to the present invention;

FIG. 5 is a graph representing a circuit size of the modular-multiplication computing unit according to the present invention; and

FIG. 6 is a graph representing a processing clock number of the modular-multiplication computing unit according to the present invention.

### DETAILED DESCRIPTION OF THE PREFERRED EMBODIMENT

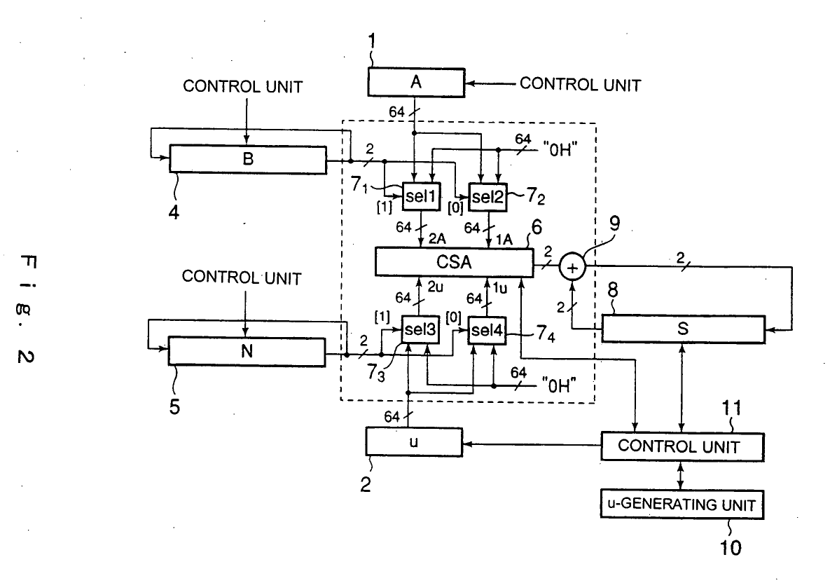

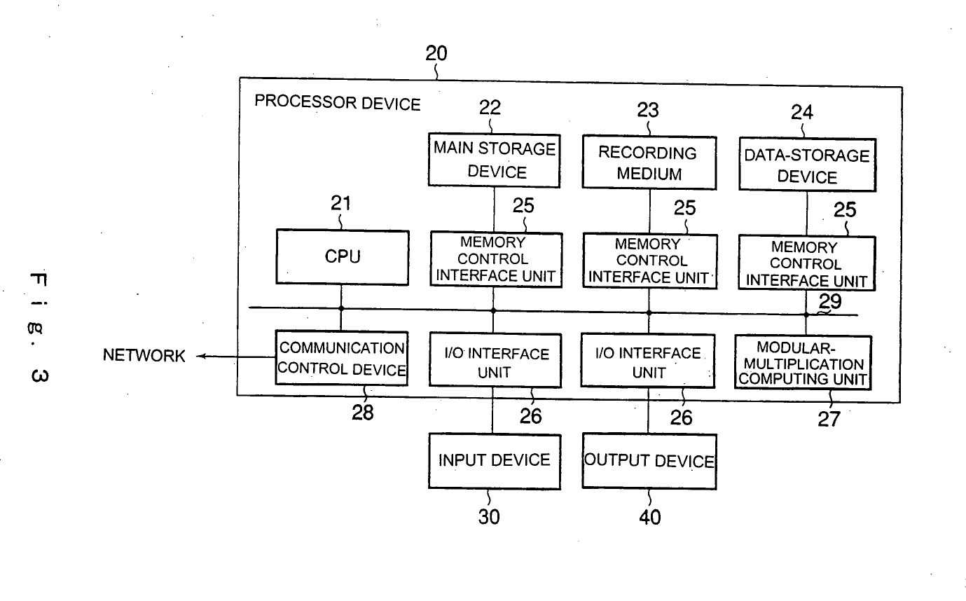

FIG. 2 is a block diagram illustrating an example of a configuration of the modular-multiplication computing unit according to the present invention, and FIG. 3 is a block diagram illustrating an example of a configuration of the information processing unit according to the present invention.

As shown in FIG. 2, the modular-multiplication computing unit of the present invention comprises: first latch circuit 1, which keeps the values of multiplicand A; second latch circuit 2, which keeps the values of multiplicand u; first shift register 4, which keeps the value of multipliers B; second shift register 5, which keeps the values of multiplier N; first selector (sel 1) 7₁ and second selector (sel 2) 7₂, which select either multiplicand A or 0 H that correspond to the value of multipliers B supplied from first shift register 4 in a unit of a plurality of bits (in FIG. 2, every two bits) and supply the selected result to CSA 6; third selector (sel 3) 7₃ and fourth selector (sel 4) 7₄, which select either multiplicand u or 0 H that correspond to the value of multipliers N supplied from second shift register 5 in a batch of a plurality of bits (in FIG. 2, every two bits) and supply the selected result to CSA 6; well-known CSA 6, which executes the operation to compute A×B+u×N through the use of the values supplied from first 7₁ to fourth 7₄ selectors; third shift register 8, which keeps the modular-multiplication operation result S provided from CSA 6 in a unit composed of a plurality of bits (in FIG. 2, every 2 bits) and supplies the kept data in a unit composed of a plurality of bits (in FIG. 2, every 2 bits); adder 9, which adds the output of third shift register 8 to the operation result of A×B+u×N delivered from CSA 6 and delivers the added result to third shift register 8 to store therein as modular-multiplication operation result S; u-generating unit 10 that stores a table for generating the value of multiplicand u; control unit 11 that provides the values of multiplicands A and u to first and second latch circuits 1, 2, respectively, the values of multipliers B, N to first and second shift registers 4, 5, respectively, and 0 H to selectors 7₁ to 7₄ and further acts to control the operations of CSA 6, u-generating unit 10 and third shift register 8.

The modular-multiplication computing unit according to the present invention operates in synchronization with an externally supplied clock signal (QK) of a predetermined frequency under condition of setting of multiplicands A and u to the latch circuits and setting multipliers B and N to the shift registers, through the control of control unit 11, which can be realized using, for example, a CPU, a DSP, logic circuits, or the like that runs a program.

In the modular-multiplication computing unit having the above circuitry according to the present invention, multiplicands A, u are each divided into a plurality of signals of the bit lengths that correspond to the processing bit length of CSA 6 and are stored in first and second latch circuits 1, 2, respectively, in a unit of the divided bit-length under control of control unit 11. Multipliers B, N, on the other hand, are stored in the first and second shift registers in a batch of the bit length that is the same as the processing bit length of the modular-multiplication computing unit under control of control unit 11. For reference, it is also feasible to divide multipliers B, N each into a plurality of signals of a predetermined bit-length batch and to store the multipliers B, N under control of control unit 11 in the first and second shift register, respectively, each in the batch of the divided bit length.

Selectors 7₁-7₄ are supplied with multiplicands A and u, respectively, from first and second latch circuits 1 and 2 in a unit of the above-described divided bit-length, and are also supplied with multipliers B and N from first and second shift registers 4, 5, respectively, in a unit of a plurality of bits. While FIG. 2 represents an example of supplying multipliers B and N on a 2-bit basis to first to fourth selectors 7₁ to 7₄, multipliers B and N can be supplied on a 4-bit or more-bit basis. For reference, while FIG. 2 represents the circuitry in which four selectors are employed for switching multiplicand A, u or 0 H, any number of selectors may be provided that multiplicand A, u or 0 H, that may be selected, correspond to the value of multiplier B or N.

First selector 7₁ and second selector 7₂ select multiplicand A (1A, 2A) or OH corresponding to the value of multiplier B supplied in a unit of a plurality of bits from first shift register 4 and supply the selected result to CSA 6. Likewise, third selector 7₃ and fourth selector 7₄ select multiplicand u (1 u, 2u) or 0 H corresponding to the value of multiplier N supplied in a unit of a plurality of bits from second shift register 5 and supply the selected result to CSA 6.

Here 1A means one time the multiplicand A and 2A means double the multiplicand A. In addition, 1 u means one time the multiplicand u and 2u means double the multiplicand u. 2A and 2u can be easily generated, because these values can be obtained, for example, by shifting the values of multiplicands A and u by one bit. While FIG. 2 represents an example in which first selector 7₁ generates 2A and third selector 7₃ generates 2u, it is also possible to generate 2A and 2u in CSA 6.

CSA 6 computes each of A×B and u×N by shift and addition of multiplicand or 0 H successively supplied from each selector and supplies the added result (modular-multiplication operation result) S to each unit composed of two or more bits. The operation result provided by CSA 6 is added to the output of third shift register 8 (modular-multiplication operation result in the past S) in a unit of a plurality of bits and the added result is again stored in third shift register 8.

For reference, first latch circuit 1, second latch circuit 2, first shift register 4, second shift register 5, third latch circuit 8 and u-generating unit 10 represented in FIG. 2 do not necessarily need to be provided within the interior of the modular-multiplication computing unit but can be provided in the information processing unit that utilizes the modular-multiplication computing unit. Likewise, it is also not necessarily required to provide control unit 11 within the modular-multiplication computing unit, but control unit 11 can be realized by the information processing unit (CPU) provided within the information processor that utilizes the modular-multiplication computing unit. Specifically, the modular-multiplication computing unit need only be provided with the constituent elements within the area shown by the dotted line in FIG. 2.

In addition, it is not always necessary to store multiplicands A and u in latch circuits, but any memory elements may be employed if the memory elements are capable of temporarily storing data, such as for example, shift registers or RAMs. Likewise, it is not always necessary to store multipliers B, N and operation result S in shift registers, but any memory elements may be employed if the memory elements are capable of delivering the stored data in a unit of a plurality of bits such as, for example, RAMs.

The information-processing device of the present invention is a computer system that consists of, for example, a personal computer and a server device, as shown in FIG. 3, and comprises a processor device 20 that runs a program to execute a predetermined process, input device 30 that receives commands, information, etc. for processor device 20 and output device 40 that delivers the processing results executed by processor device 20 to monitor the processing results.

Processor device 20 comprises: CPU 21; main storage device 22 that temporarily stores the information that CPU 21 needs to process; recording medium 23 that records programs for CPU 21 to execute the process imposed on control unit 11; data-storage device 24 that stores the data etc. required for processing; memory control interface units 25 that control data transfers with main storage device 22, recording medium 23 and data-storage device 24; I/O interface units 26 that interface with input device 30 and output device 40; modular-multiplication computing unit 27 shown in FIG. 2; and communication control device 28 that serves as an interface to control communication between networks etc; wherein the above constituent elements are interconnected by way of a bus. For reference, processor device 20 can include latch circuits for keeping multiplicands A and u and shift registers for keeping multipliers B, N and operation result S, etc. depending on the construction of modular-multiplication computing unit 27.

Processor device 20 executes the processes imposed on control unit 11 making use of CPU 21 according to the program loaded in recording medium 23 and performs the calculation of S=S+Aᵢ×B+u×N making use of modular-multiplication computing unit 27. For reference, recording medium 23 may be a magnetic disk, a semiconductor memory, an MO disk or other recording medium.

Specific explanation is next given referring to the drawings in regard to the operation of the modular-multiplication computing unit according to the present invention.

In the following description, explanation regards an example in which it is prescribed that A, u, B and N are each 512-bit; the processing bit length of employed CSA 6 is 64 bits; first and second shift registers 4, 5 supply multipliers B and N, respectively, to respective selectors on a 2-bit basis; and third shift register 8 receives and supplies modular-multiplication operation result S on a 2-bit basis. Further, it is prescribed that first and second shift registers 4,5 store multipliers B, N, respectively, on a 512-bit basis and first and second latch circuits 1, 2 store multiplicands A and u, respectively, on a 64-bit basis to accord with the processing bit length of CSA 6.

In order to supply multipliers B and N on a 2-bit basis making use of CSA 6 of a 64-bit processing bit length, the modular-multiplication operation (512 bits×512 bits×2⁻⁵¹² mode 512 bits) can be achieved using A, u, B and N of 512 bits each by making repetitive operations of 64 bits×512 bits×2⁻⁶⁴ mode 512 bits (A×B×2⁻⁶⁴ mode N).

The modular-multiplication computing unit of the present invention takes advantage of the feature in the modular-multiplication operation according to the Montgomery method in which the lowest bits are 0 (in the present case, the lowest 64 bits are 0 H) and calculates in advance the values of u corresponding to the values of the above-described S, A, B and N. The calculated results are stored in u-generating unit 10 in a table format.

For example, if the multipliers are supplied on a 2-bit basis, then the values of u are obtained as follows (wherein N is an odd integer):
if N[1:0]=01 and (S+Ai×B)[1:0]=00,
then u[1:0]=00 for S=S+Ai×B+u×N=00,
if N[1:0]=01 and (S+Ai×B)[1:0]=01,
then u[1:0]=11 for S=S+Ai×B+u×N=00,
if N[1:0]=01 and (S+Ai×B)[10]=10,
then u[1:0]=10 for S=S+Ai×B+u×N=00,
if N[1:0]=01 and (S+Ai×B)[1:0]=11,
then u[1:0]=01 for S=S+Ai×B+u×N=00,
if N[1:0]=11 and (S+Ai×B)[1:0]=00,
then u[1:0]=00 for S=S+Aix B+u×N=00,
if N[1:0]=11 and (S+Ai×B)[1:0]=01,
then u[1:0]=01 for S=S+Ai×B+u×N=00,
if N[1:0]=11 and (S+Ai×B)[10]=10,
then u[1:0]=10 for S=S+Ai×B+u×N=00, and
if N[1:0]=11 and (S+Ai×B)[1:0]=11,
then u[1:0]=11 for S=S+Ai×B+u×N=00.

The above results are summarized in Table 1.

TABLE 1

| | S + Ai x | |
|---|---|---|
| N[1] | B[1:0] | u |
| 0 | 00 | 00 |
| 0 | 01 | 11 |
| 0 | 10 | 10 |
| 0 | 11 | 01 |
| 1 | 00 | 00 |
| 1 | 01 | 01 |
| 1 | 10 | 10 |
| 1 | 11 | 11 |

Here, A, B and N are all known values (the values stored in first latch circuit 1, first shift register 4 and second shift register 5, respectively) and S is also a known value because 0 H (at the initiation time of the operation) or the preceding operation result of 64 bits×512 bits×2⁻⁶⁴ mode 512 bits is used for S. For reference, N is an odd number and consequently fixed to N[1:0]=01 or 11. Then, the values of multiplicand u calculated on the basis of the values of A, B and S are stored in a table format in advance in u-generating unit 10, and control unit 11 decides on the value of multiplicand u by consulting the table. In this regard, Table 2 represents a table for generating the u to be used in cases where multipliers B and N are supplied on a 4-bit basis.

TABLE 2

| N[3:1] | |
|---|---|
| S + AB[3:0] | u |
| 0 | 0 |
| 1 | 15 |
| 2 | 14 |
| 3 | 13 |
| 4 | 12 |
| 5 | 11 |
| 6 | 10 |
| 7 | 9 |
| 8 | 8 |
| 9 | 7 |
| 10 | 6 |
| 11 | 5 |
| 12 | 4 |
| 13 | 3 |
| 14 | 2 |
| 15 | 1 |
| 16 | 0 |
| 17 | 5 |
| 18 | 10 |
| 19 | 15 |
| 20 | 4 |
| 21 | 9 |
| 22 | 14 |
| 23 | 3 |
| 24 | 8 |
| 25 | 13 |
| 26 | 2 |
| 27 | 7 |
| 28 | 12 |
| 29 | 1 |
| 30 | 6 |
| 31 | 11 |
| 32 | 0 |
| 33 | 3 |
| 34 | 6 |
| 35 | 9 |
| 36 | 12 |
| 37 | 15 |
| 38 | 2 |
| 39 | 5 |
| 40 | 8 |
| 41 | 11 |
| 42 | 14 |
| 43 | 1 |
| 44 | 4 |
| 45 | 7 |
| 46 | 10 |
| 47 | 13 |
| 48 | 0 |
| 49 | 9 |
| 50 | 2 |
| 51 | 11 |
| 52 | 4 |
| 53 | 13 |
| 54 | 6 |
| 55 | 15 |
| 56 | 8 |
| 57 | 1 |
| 58 | 10 |
| 59 | 3 |
| 60 | 12 |
| 61 | 5 |
| 62 | 14 |
| 63 | 7 |
| 64 | 0 |
| 65 | 7 |
| 66 | 14 |
| 67 | 5 |
| 68 | 12 |
| 69 | 3 |
| 70 | 10 |
| 71 | 1 |
| 72 | 8 |
| 73 | 15 |
| 74 | 6 |
| 75 | 13 |
| 76 | 4 |
| 77 | 11 |
| 78 | 2 |
| 79 | 9 |
| 80 | 0 |
| 81 | 13 |
| 82 | 10 |
| 83 | 7 |
| 84 | 4 |
| 85 | 1 |
| 86 | 14 |
| 87 | 11 |
| 88 | 8 |
| 89 | 5 |
| 90 | 2 |
| 91 | 15 |
| 92 | 12 |
| 93 | 9 |
| 94 | 6 |
| 95 | 3 |
| 96 | 0 |
| 97 | 11 |
| 98 | 6 |
| 99 | 1 |
| 100 | 12 |
| 101 | 7 |
| 102 | 2 |
| 103 | 13 |
| 104 | 8 |
| 105 | 3 |
| 106 | 14 |
| 107 | 9 |
| 108 | 4 |
| 109 | 15 |
| 110 | 10 |
| 111 | 5 |
| 112 | 0 |
| 113 | 1 |
| 114 | 2 |
| 115 | 3 |
| 116 | 4 |
| 117 | 5 |
| 118 | 6 |
| 119 | 7 |
| 120 | 8 |
| 121 | 9 |
| 122 | 10 |
| 123 | 11 |
| 124 | 12 |
| 125 | 13 |
| 126 | 14 |
| 127 | 15 |

In the modular-multiplication computing unit of the present invention, control unit 11 sets the lowest 64-bit data of multiplicand A (512 bits) in first latch circuit 1, sets the data of multiplier B (512 bits) in first shift register 4 and sets the data of multiplier N (512 bits) in second shift register 5.

Subsequently, control unit 11 determines the value of u (for 64 bits) by consulting the table stored in u-generating unit 10 on the basis of 64-bit multiplicand A, 64-bit multiplier B and 64-bit multiplier N, and stores the determined value of u in second latch circuit 2.

When completing the setting of the multiplicands or multipliers in first and second latch circuits 1, 2, and in first and second shift registers 4, 5 under control of control unit 11, the modular-multiplication computing unit starts computing S=S+A×B+u×N.

The modular-multiplication computing unit at first selects either multiplicand A (64 bits) or 0 H at first and second selectors 7₁, 7₂ depending on the value of 2-bit multiplier B supplied from first shift register 4 and provides the selected result to CSA 6. In the present embodiment, first selector 7₁ switches 0 H/2A (switches between 0 H and 2A) and second selector 7₂ switches 0 H/1 A.

Similarly, the modular-multiplication computing unit selects either multiplicand u (64 bits) or 0 H at third and fourth selectors 7₃, 7₄ depending on the value of 2-bit multiplier N supplied from second shift register 5 and provides the selected result to CSA 6. In the present embodiment, third selector 7₃, switches 0 H/2u and fourth selector 7₄ switches 0 H/1u.

CSA 6 computes A×B and u×N by performing addition-with-carry operations of the values of multiplicands and 0 H successively supplied from respective selectors and supplies the added result (modular-multiplication operation result) S on a 2-bit basis. The operation result provided from CSA 6 is added to the output of third shift register 8 on the 2-bit basis at adder 9 and the added value is stored again in third shift register 8.

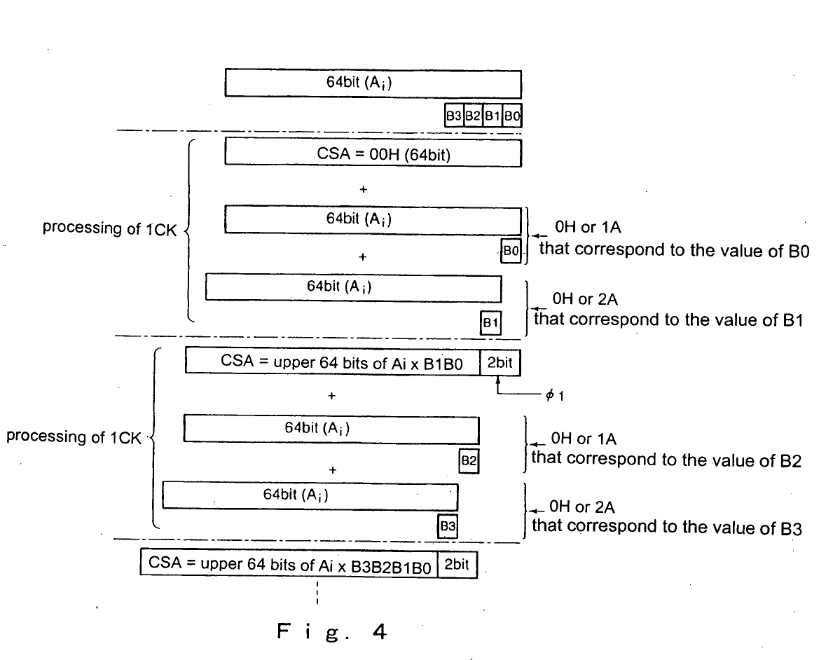

FIG. 4 represents the procedures for the processing of A×B included in the operation executed by the modular-multiplication computing unit of the present invention. The operation of u×N is analogous to the operation of A×B shown in FIG. 4. The added result of the lowest 2 bits (φ1) of the operation result of A×B shown in FIG. 4 and the lowest 2 bits of the operation result of u×N obtained by analogous processing are provided from CSA 6 as output (2 bits).

Repetitively executing this processing for the entire bit data stored in first and second shift registers 4 and 5 leads to completion of the operation of 64 bits×512 bits×2⁻⁶⁴ mod 512 bits. In this operation step, however, upper 64 bits of the operation results of partial products remain in CSA 6. Thus, the remaining data is stored in third shift register 8 pursuant to the instruction of control unit 11. Consequently, the operation result S of 64 bits×512 bits×2⁻⁶⁴ mod 512 bits is stored in third shift register 8.

When completing the operation of 64 bits×512 bits×2⁻⁶⁴ mod 512 bits, the modular-multiplication computing unit sets the next lowest 64-bit data (the data from the 65th bit to the 128th bit counted from the lowest bit) of multiplicand A into first latch circuit 1 under control of control unit 11. Further, the modular-multiplication computing unit, as in the above case, obtains the value of multiplicand u by consulting the table in u-generating unit 10, stores the obtained value in second latch circuit 2 and again starts the operation of 64 bits×512 bits×2⁻⁶⁴ mod 512 bits.

Thereafter, similar processing is repetitively executed on the entire bit data of multiplicand A (512 bits) stored in first latch circuit 1, i.e., the operation of the above 64 bits×512 bits×2⁻⁶⁴ mod 512 bits is repeated 8 times. Thus, the modular-multiplication computing unit completes the operation of 512 bits×512 bits×2⁻⁵¹² mod 512 bits.

Explanation is next presented regarding the technical merits of the modular-multiplication computing unit of the present invention with reference to drawings.

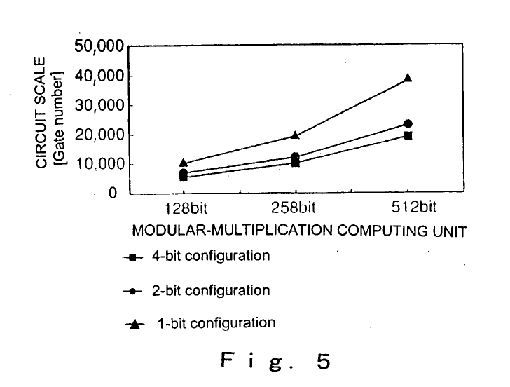

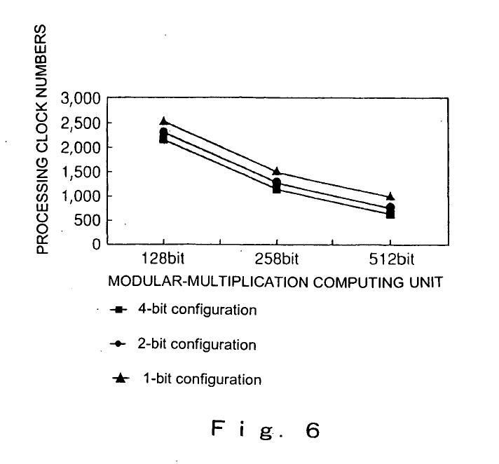

FIG. 5 is a graph representing the circuit size of the modular-multiplication computing unit according to conventional technology, which supplies a multiplier on a 1-bit basis, and the modular-multiplication computing unit according to the present invention, which supplies a multiplier on a 2-bit or 4-bit basis. FIG. 6 is a graph representing the processing clock numbers of the modular-multiplication computing unit according to conventional technology, which supplies a multiplier on a 1-bit basis, and the modular-multiplication computing unit according to the present invention, which supplies a multiplier on a 2-bit or 4-bit basis. For reference, FIG. 6 represents a clock number required for the modular-multiplication operation on the assumption that the processing bit length of the modular-multiplication computing unit is 512 bits.

The 1-bit configuration represented in FIGS. 5 and 6 refers to the configuration of the conventional modular-multiplication computing unit that supplies the multiplier on a 1-bit basis, the 2-bit configuration refers to the configuration of the modular-multiplication computing unit of the present invention that supplies the multiplier on a 2-bit basis, and the 4-bit configuration refers to the configuration of the modular-multiplication computing unit of the present invention that supplies the multiplier on a 4-bit basis. Also, in the explanation below the terms, 1-bit configuration, 2-bit configuration and 4-bit configuration mean the same configurations.

In addition, the abscissas of the graphs represented in FIGS. 5 and 6 represent the processing bit length (128 bits, 256 bits and 512 bits) of the modular-multiplication computing unit and it is assumed in the explanation given below that if the processing bit length of a modular-multiplication computing unit is the same, then the processing bit length of CSA 6 is reduced in inverse proportion to the output bit number of the multiplier. The relation between the processing bit length and output bit number is shown in Table 3, wherein each entry of Table 3 represents the results of the processing bit length of CSA times the output bit number.

TABLE 3

| modular- | | | |
|---|---|---|---|
| multiplication | 4-bit | 2-bit | 1-bit |
| computing unit | configuration | configuration | configuration |
| 128 bits | 32 bits × 4 bits | 64 bits × 2 bits | 128 bits × 1 bits |
| 256 bits | 64 bits × 4 bits | 128 bits × 2 bits | 256 bits × 1 bits |
| 512 bits | 128 bits × 4 bits | 256 bits × 2 bits | 512 bits × 1 bits |

FIG. 5 shows that, if the processing bit lengths of a modular-multiplication computing unit are the same, the modular-multiplication computing unit of the present invention, which enables processing a multiplier on a plurality-of-bit basis, has a reduced circuit size as compared to the conventional modular-multiplication computing unit, which processes a multiplier on a 1-bit basis.

Comparison between the conventional modular-multiplication computing unit of the 1-bit configuration and the modular-multiplication computing unit of the 2-bit configuration of the present invention with reference to FIG. 5 shows that the modular-multiplication computing unit of the present invention has about half the circuit size of the conventional unit. This is because the 2-bit configuration makes it possible to configure the processing bit length of CSA 6 to be one half that of the conventional unit and the 4-bit configuration makes it possible to configure the processing bit length of CSA 6 to be one quarter that of the conventional unit.

For example, if it is assumed that the processing bit length of a modular-multiplication computing unit is 128 bits, then, the conventional modular-multiplication computing unit will need to keep 128 values for each of SUM (addition result) and CARRY and thus necessitates 256 flip-flops (Data F/F).

In contrast, a processing bit length of only 64 bits, one half that of the conventional unit, suffices for CSA 6 provided in the modular-multiplication computing unit of the 2-bit configuration according to the present invention and thus necessitates 128 flip-flops to keep values of SUM (addition result) and CARRY (carry), i.e., supplying a multiplier on a plurality-of-bit basis makes it possible to significantly reduce the number of flip-flops provided in CSA 6, entailing reduction of the circuit size.

On the other hand, provided that the processing bit lengths of a modular-multiplication computing unit are the same, the processing clock number is lower in the modular-multiplication computing unit of the present invention, which supplies a multiplier on a plurality-of-bit basis, than in the conventional modular-multiplication computing unit, which supplies a multiplier on a 1-bit basis, as shown in FIG. 6. This is due to the difference in the processing times for issuing the operation results still remaining in CSA 6.

In the modular-multiplication computing unit of the present invention, while the processing bit length of CSA 6 is made one half or one quarter that of the conventional modular-multiplication computing unit, there is a step for processing the divided multiplicand, and thus the modular-multiplication operation needs to be repeated many times. As a result, in the modular-multiplication computing unit of the present invention, the number of repetitions in the repetitive operation is increased as compared to that in the conventional modular-multiplication computing unit, and the number of output times of the operation results of partial products remaining in CSA 6 is also increased.

In the modular-multiplication computing unit of the present invention, however, the processing bit length in CSA 6 can be reduced as described above and thus, the reduced processing bit length will cause a reduction in the processing time for issuing the operation result remaining in CSA 6 such that in the case of a 2-bit configuration, the processing time becomes one half the processing time in the conventional modular-multiplication computing unit and in the case of a 4-bit configuration, the processing time becomes one quarter the processing time in the conventional unit. For this reason, the processing time of one modular-multiplication operation for A, u, B and N is reduced as compared to the conventional case, but the reduction is only slight.

Although the modular-multiplication computing unit of the present invention is unable to realize a significant reduction in processing time, even the slight improvement in reducing processing time can be greatly advantageous if the modular-multiplication computing unit of the present invention is employed to encrypt and decrypt RSA cryptography in which the modular exponentiation operations of large values, for an alignment of a multitude of numerics, are executed.

Now, assuming that the output bit number of multipliers B and N is q, multiplicand u can be calculated using the equations below based on the algorithm (1), (5) obtained by applying the above-described Montgomery method.
v=−N⁻¹ mod 2^{-q}, and
u=Sv mod 2^{q},
where v is calculated only once at the startup of the computation. For reference, the reason for putting 2^{q} in place of r is that r is expressed in a binary number.

In the case of the conventional modular-multiplication computing unit in which q=1, v=1 because N is an odd number. Thus, u=S mod 2=S[0]. Therefore, multiplicand u becomes equal to the lowest bit of S. For this reason, it is not necessary actually to calculate multiplicand u.

However, in the modular-multiplication computing unit of the present invention in which q>1, u=S[0] does not keep. Thus, the above two operations need to be executed. In this regard, in the case where the value of q is small (for example q=2, or 4), v and u are also of 2 bits or 4 bits, and N and S, which are necessary for the operations, are also of 2 bits or 4 bits. Allowing for this fact, the present invention pre-computes the value of u from the values of A, B, S and N to make a table, based on which the value of u is determined and stored in second latch circuit 2. The greater value of q enables the shorter processing bit length of CSA 6, thereby further reducing the processing time of the modular-multiplication operation.

However, if q>4, i.e., in the configuration of supplying multipliers B and N in a 8-bit or more batch, the circuit size of, for example, a decoder, which is required for selecting multiplicand u from the values listed in the table, increases. Consequently, the circuit size of u-generating unit 10 including a memory element increases, canceling the advantage of reduction in the circuit size of the modular-multiplication computing unit, which originates from the reduction in the processing bit length in CSA 6, as described above.

Table 4 represents a layout area (unit: mm²) of u-generating unit 10 for q values, and Table 5 represents the total layout area (unit: mm²) including the CSA and u-generating unit for q values.

TABLE 4

| q = 1 | q = 2 | q = 4 | q = 8 |
|---|---|---|---|
| 0 | 0.003 | 0.014 | 0.937 |

TABLE 5

| CSA + u- | | | | |
|---|---|---|---|---|
| generating | | | | |
| unit | q = 1 | q = 2 | q = 4 | q = 8 |
| 32 bits | 0.103 | 0.169 | 0.308 | 1.371 |
| 64 bits | 0.292 | 0.423 | 0.529 | 1.903 |
| 128 bits | 0.580 | 0.842 | 1.171 | 2.988 |
| 256 bits | 1.153 | 1.691 | 2.310 | 5.135 |

Table 4 and Table 5 show that, compared to the total layout area for, for example, the processing bit length of a CSA designed to be 256 bits and q=1, the total layout area decreases in the case where q=2 and the processing bit length of a CSA can be designed to be 128 bits, and also in the case where q=4 and the processing bit length of a CSA can be designed to be 64 bits. If q=8, however, the total layout area increases.

Thus, it is desirable for the modular-multiplication computing unit of the present invention that the value of q is 2 or 4 in order to reduce the processing time while preventing an increase in the circuit size. In this regard, if the intention is to give preference to improvement of the processing time over the circuit size, however, it is permissible to set the value of q to be 8 or more. In such a case, it is recommended optimal value of q be selected taking into account an increase in the layout area of u-generating unit 10.

While a preferred embodiment of the present invention has been described using specific terms, such description is for illustrative purposes only, and it is to be understood that changes and variations may be made without departing from the spirit or scope of the following claims.

What is claimed is:

1. A modular-multiplication computing unit for computing S=S+A×B+u×N wherein A and u denote multiplicands, B and N denote multipliers and S denotes a result of modular-multiplication operation, comprising:
selectors that select either a value of said multiplicand A or a value of 0, depending on a value of said multiplier B supplied in a unit composed of a plurality of bits q, and supply the selected result and that select either a value of said multiplicand u or the value of 0, depending on a value of said multiplier N supplied in a unit composed of said plurality of bits q, and supply the selected result,
a carry save adder that executes the operation of A×B+u×N through the use of values successively supplied from said selectors, and
an adder that adds the operation result of said A×B+u×N supplied in a unit composed of said q bits from said carry save adder and the operation result made in the past supplied in a unit composed of said q bits and provides the added result as said result of modular-multiplication operation S.

2. The modular-multiplication computing unit according to claim 1, further comprising a first memory element that keeps said multiplicand A and supplies it to said selector,
a second memory element that keeps said multiplicand u and supplies it to said selector,
a third memory element that keeps said multiplier B and supplies it to said selector in a unit composed of said q bits,
a fourth memory element that keeps said multiplier N and supplies it to said selector in a unit composed of said q bits, and
a fifth memory element that keeps said result of modular-multiplication operation S supplied from said adder and supplies said result of modular-multiplication operation S to said adder in a unit composed of said q bits.

3. The modular-multiplication computing unit according to claim 1, further comprising a control unit that controls the operation of said carry save adder.

4. The modular-multiplication computing unit according to claim 3, wherein said control unit
sets said multiplicand A to said first memory element,
sets said multiplicand u to said second memory element,
sets said multiplier B to said third memory element,
sets said multiplier N to said fourth memory element, and
supplies 0 to said selector.

5. The modular-multiplication computing unit according to claim 3, further comprising a u-generating unit that stores pre-computed relationships of the values of said multiplicand u to the values of said multiplicand A, said multiplier B, said multiplier N and said result of modular-multiplication operation S, wherein
said control unit, when computing said S=S+A×B+u×N, consults said u-generating unit and determines the value of said multiplicand u.

6. The modular-multiplication computing unit according to claim 1, wherein said bit number q is 2.

7. The modular-multiplication computing unit according to claim 1, wherein said bit number q is 4.

8. The modular-multiplication computing unit according to claim 2, wherein said first memory element and said second memory element are latch circuits.

9. The modular-multiplication computing unit according to claim 2, wherein said third memory element, said fourth memory element and said fifth memory element are shift registers.

10. An information processing unit, comprising:
a modular-multiplication computing unit according to claim 1,
a first memory element that keeps said multiplicand A and supplies it to said selector,
a second memory element that keeps said multiplicand u and supplies it to said selector,
a third memory element that keeps said multiplier B and supplies it to said selector in a unit composed of said q bits,
a fourth memory element that keeps said multiplier N and supplies it to said selector in a unit composed of said q bits, and
a fifth memory element that keeps said result of modular-multiplication operation S supplied from said adder and supplies said result of modular-multiplication operation S to said adder in a unit composed of said q bits.

11. The information processing unit according to claim 10, further comprising a control unit that controls the operation of said carry save adder.

12. The information processing unit according to claim 11, wherein said control unit
sets said multiplicand A to said first memory element,
sets said multiplicand u to said second memory element,
sets said multiplier B to said third memory element,
sets said multiplier N to said fourth memory element, and
supplies 0 to said selector.

13. The information processing unit according to claim 11, further comprising a u-generating unit that stores pre-computed relationships of the values of said multiplicand u to the values of said multiplicand A, said multiplier B, said multiplier N and said result of modular-multiplication operation S, wherein
said control unit, when operating said S=S+A×B+u×N, consults said u-generating unit and determines the value of said multiplier u.

14. The information processing unit according to claim 10, wherein said bit number q is 2.

15. The information processing unit according to claim 10, wherein said bit number q is 4.

16. the information processing unit according to claim 10, wherein said first memory element and said second memory element are latch circuits.

17. The information processing unit according to claim 10, wherein said third memory element, said fourth memory element and said fifth memory element are shift registers.
